(19) United States
(12) Patent Application Publication
(10) Pub. No.: US 2023/0418516 A1
(43) Pub. Date: Dec. 28, 2023

(54) TRANSPORT BRIDGE AND PROTOCOL DEVICE FOR EFFICIENT PROCESSING IN A DATA STORAGE ENVIRONMENT

(71) Applicant: Seagate Technology, LLC, Fremont, CA (US)

(72) Inventors: Richard O. Weiss, Superior, CO (US); Jason Matthew Feist, Minneapolis, MN (US); Steven Williams, Longmont, CO (US); Hemant Vitthalrao Mane, Pune (IN)

(21) Appl. No.: 17/848,151

(22) Filed: Jun. 23, 2022

(51) Int. Cl. G06F 3/06

(52) U.S. Cl. CPC G06F 3/0659; G06F 3/0656; G06F 3/0664; G06F 3/0619; G06F 3/0689

(57) ABSTRACT

Apparatus and method for servicing data transfer commands in a computer environment using a selected protocol such as NVMe (Non-Volatile Memory Express). In some embodiments, a secure connection is established between a client device and a bridge device across an interface. A controller of the bridge device presents a unitary namespace as an available memory space to the client device. The controller further communicates with a plurality of downstream target devices to allocate individual namespaces within main memory stores of each of the target devices to form a consolidated namespace to support the unitary namespace presented to the controller. In this way, the bridge device can operate as an NVMe controller with respect to the client device for the unitary namespace, and as a virtual client device to each of the target devices which operate as embedded NVMe controllers for the individual namespaces.

### SUMMARY

Various embodiments of the present disclosure are generally directed to the efficient and secure processing of data in a distributed network environment using a selected protocol, such as but not limited to NVMe (Non-Volatile Memory Express).

In some embodiments, a secure connection is established between a client device and a bridge device across an interface. A controller of the bridge device presents a unitary namespace as an available memory space to the client device. The controller further communicates with a plurality of downstream target devices to allocate individual namespaces within main memory stores of each of the target devices to form a consolidated namespace to support the unitary namespace presented to the controller. In this way, the bridge device can operate as an NVMe controller with respect to the client device for the unitary namespace, and as a virtual client device to each of the target devices which operate as embedded NVMe controllers for the individual namespaces.

These and other features which may characterize various embodiments can be understood in view of the following detailed discussion and the accompanying drawings.

### BRIEF DESCRIPTION OF THE DRAWINGS

FIG. 1 provides a functional block representation of a system having a client (source) device coupled to a data storage (target) device constructed and operated in accordance with various embodiments.

FIG. 2 shows aspects of a computer network configured to operate in accordance with the NVMe specification in accordance with some embodiments of the present disclosure.

FIG. 3 illustrates aspects of another computer network that uses a bridge device and an array of data storage devices as a particular embodiment of the system of FIG. 2 in accordance with some embodiments.

FIG. 4 shows a functional block representation of a bridge device corresponding to FIG. 3 in some embodiments.

FIG. 5 depicts different divisions of namespace storage that can be carried out by the bridge device of FIG. 4 in various alternative embodiments.

FIG. 6 shows aspects of another computer network with a bridge device configured as a data storage device in some embodiments.

FIG. 7 is a functional block representation of the target storage device in FIG. 6 in accordance with some embodiments.

FIG. 8 depicts an authentication sequence that can be carried out in accordance with various embodiments.

FIG. 9 shows a transport bridge and protocol functionality sequence to illustrate various operations that may be carried out in accordance with some embodiments.

FIG. 10 shows another bridge device that operates using a virtual machine (VM) to execute various bridge and protocol functions of FIG. 9 in some embodiments.

FIG. 11 is a functional block depiction of a storage device corresponding to the device in FIG. 1 which is utilized in accordance with various embodiments and which is configured as a solid-state drive (SSD).

FIG. 12 shows another depiction of a bridge device in conjunction with multiple target devices in accordance with further embodiments.

### DETAILED DESCRIPTION

The present disclosure is generally directed to systems and methods for performing data transfers in a secure and efficient manner.

Data storage devices store and retrieve computerized data in a fast and efficient manner. A data storage device usually includes a top level controller and a main memory store, such as a non-volatile memory (NVM), to store data associated with an client device. The NVM can take any number of forms, including but not limited to rotatable media and solid-state semiconductor memory.

Computer networks are arranged to interconnect various devices to enable data exchange operations. It is common to describe such exchange operations as being carried out between a client device and a data storage device. Examples of computer networks of interest with regard to the present disclosure include public and private cloud storage systems, local area networks, wide area networks, object storage systems, the Internet, cellular networks, satellite constellations, storage clusters, etc. While not required, these and other types of networks can be arranged in accordance with various industry specifications in order to specify the interface and operation of the interconnected devices.

One commonly utilized industry specification is referred to as Non-Volatile Memory Express (NVMe), which generally establishes NVMe domains (namespaces) to expedite parallel processing and enhance I/O throughput accesses to the NVM memory in the network. NVMe provides enhanced command processing, enabling up to 64K command queues each capable of accommodating up to 64K pending commands.

Another specification is referred to as Compute Express Link (CXL) which enhances high speed central processing unit (CPU) to device and CPU to memory data transfers. CXL enables efficiencies in I/O data transfers, caching and memory through the sharing of resources between the source and the target devices. Both NVMe and CXL are particularly suited to the use of Peripheral Computer Interface Express (PCIe) interfaces, although other types of interfaces can be used.

While operable, these and other techniques can present challenges when operating in various environments, including high volume and low trust environments. To this end, various embodiments of the present disclosure are generally directed to the use of one or more bridge devices to interface and manage the storage and retrieval of client data.

As explained below, some embodiments include operational steps such as coupling and establishing a secure connection between a client device and a data processing device across an interface. The data processing device is sometimes referred to as a bridge device (also a transport bridge device, or a transport and protocol bridge device). The bridge device may take a variety of forms including a data storage device. A controller of the bridge device establishes a transport bridge that presents the bridge device to the host device as a unitary target using a selected transport protocol. One particularly suitable protocol is the NVMe specification, although other protocols can be used.

Thereafter, the controller of the bridge device communicates with a plurality of downstream data storage devices to emulate the selected protocol and service access commands from the client device. In some embodiments, an emulated namespace, such as an NVMe namespace, is managed at the bridge device level, and the actual storage is carried out using individual target namespaces at the storage device level.

In this way, the system can be configured such that the bridge device presents the external network with an essentially conventionally behaving interface in accordance with the selected protocol. From this point downstream, the bridge device emulates a target which is made up of a number of downstream target devices (such as separate SSDs, etc.). While not necessarily required, RAID techniques may be used to generate parity and other operations, so that the data and parity values distributed across the various storage devices as desired in accordance with the associated RAID level. Each of these separate downstream storage devices may be treated as a separate namespace. Further embodiments can use CMB (controller memory buffer) and VM (virtual machine) techniques on the downstream side.

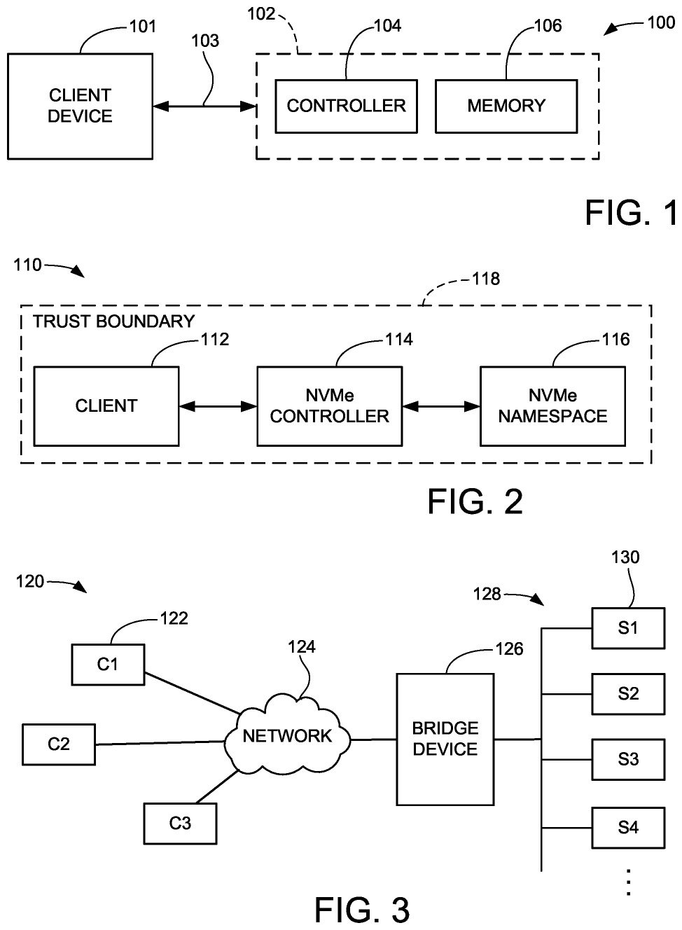

These and other features and advantages of various embodiments can be understood beginning with a review of FIG. 1 which shows a functional block representation of aspects of a data processing network 100. The network 100 includes a client device 101 coupled to a data storage device 102 using a suitable interface 103. The client device 101 will sometimes be referred to herein as a source device and the data storage device 102 will sometimes be referred to herein as a target device. Other types of source and target devices can be used.

The client device 101 can take any number of desired forms including but not limited to a host device, a server, a RAID controller, a router, a network accessible device such as a tablet, smart phone, laptop, desktop, workstation, gaming system, other forms of user devices, etc. While not limiting, the client device 101 is contemplated as having at least one controller, which may include one or more hardware or programmable processors, as well as memory, interface electronics, software, firmware, etc. As described herein, programmable processors operate responsive to program instructions that are stored in memory and provide input instructions in a selected sequence to carry out various intended operations. Hardware processors utilize hardwired gate logic to perform the required logic operations.

The data storage device 102 can take any number of desired forms including a hard disc drive (HDD), a solid-state drive (SSD), a hybrid drive, an optical drive, a thumb drive, a network appliance, a mass storage device (including a storage enclosure having an array of data storage devices), etc. Regardless of form, the data storage device 102 is configured to store user data provided by the client device 101 and retrieve such data as required to authorized devices across the network, including but not limited to the initiating client device 101 that supplied the stored data.

The interface 103 provides wired or wireless communication between the respective client and storage devices 101, 102, and may involve local or remote interconnection between such devices in substantially any desired computational environment including local interconnection, a local area network, a wide area network, a private or public cloud computing environment, a server interconnection, the Internet, a satellite constellation, a data cluster, a data center, etc. While PCIe is contemplated as a suitable interface protocol for some or all of the interconnections between the respective devices 101/102, such is not necessarily required.

The data storage device 102 includes a main device controller 104 and a memory 106. The main device controller 104 can be configured as one or more hardware based controllers and/or one or more programmable processors that execute program instructions stored in an associated memory. The memory 106 can include volatile or non-volatile memory storage including flash, RAM, other forms of semiconductor memory, rotatable storage discs, etc. The memory can be arranged as a main store to store user data from the client device as well as various buffers, caches and other memory to store user data and other types of information to support data transfer and processing operations.

FIG. 2 depicts aspects of a computer network 110 in accordance with some embodiments of the present disclosure. The network 110 includes a client device coupled to a data storage device in a manner similar to that shown above in FIG. 1. The client device is denoted at 112. Aspects of the data storage device include an NVMe controller 114 and an NVMe namespace 116. The namespace 116 is an allocated portion of memory available for use by the client device 112.

The namespace may constitute all of the available capacity of the NVM memory of the device (see e.g., 106 in FIG. 1), a portion of this overall memory, or some or all of this memory in combination with additional memory in one or more data storage device. Multiple namespaces may thus be generated, used and deleted as required under the direction and control of the NVMe controller 114. Security protocols may be used to ensure authorized access by the client, such as via authentication techniques as known in the art to form a trust boundary 118 in which the various elements are operated. While the system 110 in FIG. 2 is contemplated as being configured to operate in accordance with the NVMe specification, such is merely illustrative and not limiting. Other protocols can be established and used to manage the allocation of memory and storage of data therein by the client.

At this point it will be noted that the respective elements in FIG. 2 are realized at different layers and levels in various embodiments. This can be understood beginning with a review of FIG. 3, which provides a diagram of another data network 120 in accordance with further embodiments. The network shows various elements generally corresponding to those discussed above in FIGS. 1-2, including various client devices 122 (denoted as C1-C3). An intervening network 124 can take any number of suitable forms including local wired or wireless networks, a cloud computing network, the Internet, etc. to enable interconnection between the respective client devices 122 and a bridge device 126. The bridge device 126, also sometimes referred to as a data processing device, provides front end emulation and control of one or more namespaces (allocatable memory) to the respective clients, including but not limited to NVMe namespaces.

Each namespace is in turn managed by the bridge circuit 126 via an array of data storage devices 128 formed from individual storage devices 130 (denoted S1 through S4). Any number and types of storage devices can be used.

The bridge device 126 manages both transport bridge and transport protocol functions for the storage of data among the respective storage devices 130. As used herein, the term transport bridge will be understood to generally describe the processing capabilities of the bridge device to manage input access commands from the external network. The term transport protocol will be understood to generally describe the mechanisms employed by the bridge device 126 to translate between the conventions utilized by the external devices (e.g., clients 122) as compared to the mechanisms utilized by the internal devices downstream of the transport bridge (e.g., storage devices 130).

NVMe is a particularly suitable protocol that can be used in at least some embodiments of the present disclosure. In this case, NVMe can be run at multiple levels, including at the network level (e.g., as presented and interfaced upstream from the bridge device) and at the storage level (e.g., as presented and interfaced downstream from the bridge device). However, any number of different industry standard and proprietary protocols can be utilized to manage namespaces (e.g., allocated units of storage accessible by an authorized owner/client).

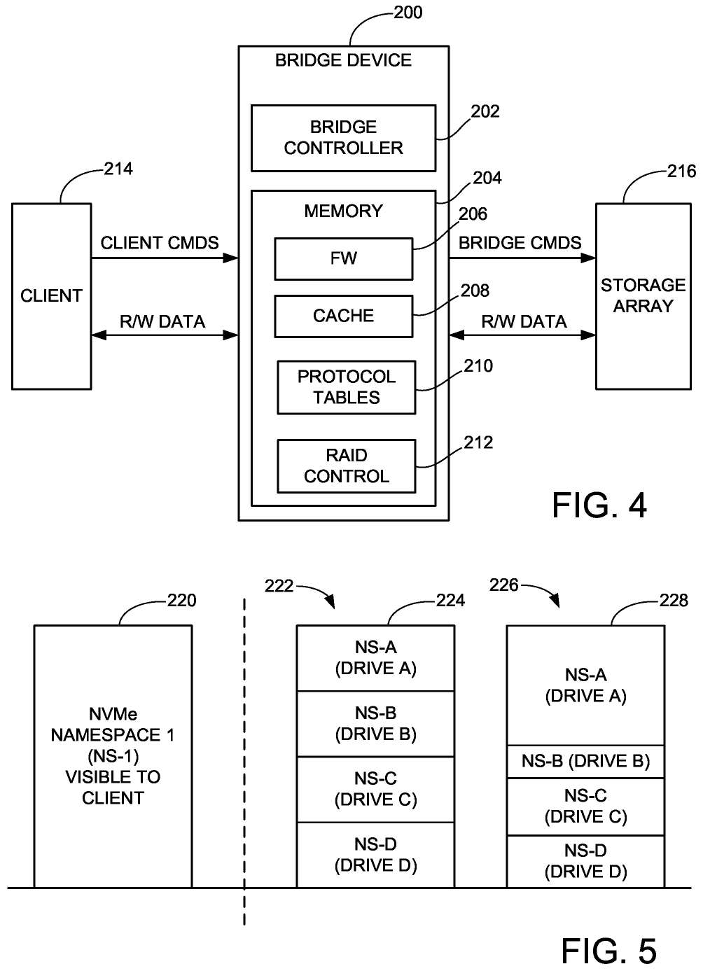

FIG. 4 is a functional block representation of a bridge device 200 generally corresponding to the bridge device 126 in FIG. 3 in accordance with some embodiments. The bridge device 200 is characterized as a data processing device having a bridge controller 202 and a bridge memory 204. It will be appreciated that in at least some embodiments, the elements 202/204 can correspond to the elements 104/106 in FIG. 1.

In the embodiment of FIG. 4, the bridge controller 202 incorporates one or more programmable processors. These processors may be characterized as ARMs, or Advanced RISC Machines (“Reduced Instruction Set Computing” devices). As will be recognized, an ARM is a specially configured processor with a reduced, tailored set of commands to carry out computational and processing functions in a fast and efficient manner.

The memory 202 may incorporate several different types and configurations of semiconductor and/or disc-based memory. Aspects of the memory may be volatile or non-volatile. In the embodiment of FIG. 4, it is contemplated that the memory 204 provides storage of a number of different data and programming structures, including firmware (FW) 206, cache 208 in the form of one or more data caches/buffers, a protocol table 210 in the form of one or more protocol translation table structures, and one or more RAID control structures 212.

The FW 206 can represent program instructions executed by the controller 202 during operation. The cache 208 can include read data buffers to temporarily cache data being transferred to the requesting client from the consolidated namespace, and write caches used to temporarily cache data being transferred from the requesting client to the consolidated namespace.

The table 210 provides translation data to enable the bridge device 200 to coordinate the input commands and direct the requisite data transfers among the downstream data storage devices. The consolidated namespace presented to the upstream device(s) is managed internally at this level. One or more translation layers may be provided to coordinate and direct addresses to the respective downstream devices. In the environment of NVMe, a consolidated namespace at the client level may be broken up into multiple target NVMe namespaces that are in turn managed by the bridge device 200. In this way, each device 130 (FIG. 3) may receive inputs to handle independent namespaces, and the results are combined by the bridge device 200 for transfers with the associated client device.

While not limiting, it is contemplated that RAID (redundant array of independent/inexpensive discs) techniques can be used to arrange and distribute the client data among the respective devices (FIG. 3). It will be recognized that RAID techniques can be identified by a number of levels, including but not limited to RAID-(data striping across multiple devices), RAID-1 (data mirroring/duplication across multiple devices), RAID-5 (striping with parity across multiple devices), RAID-6 (striping with double parity across multiple devices), RAID-10 (striping and mirroring across multiple devices), etc. Other distributed data mechanisms can be utilized as desired, so the use of RAID techniques are contemplated but not necessarily required.

Accordingly, the RAID control block 212 in FIG. 4 can be used to this end; for example, a large block of data received from a selected client device, such as denoted at 214, can be divided out by the bridge device 200 into multiple segments, with each segment written to a different namespace among the downstream devices in a target storage array 216.

For example, if a RAID-5 arrangement is used, then the input data from the client device can be broken into N total blocks of data made up of N-1 user data stripes plus 1 stripe of parity data. Each of the separate blocks can thereafter be written to the downstream storage devices (denoted at 214 in FIG. 4). Each storage device operates as if an NVMe controller is operating as in FIG. 2, and services the received data transfer (e.g., read/write) commands to that portion of memory allocated to the associated namespace.

FIG. 5 is a graphical representation of the distribution of data that can be managed using the bridge and protocol functions of the bridge device 200 of FIG. 4 in some embodiments. Block 220 represents a total volume of allocatable space associated with a selected client-level namespace, such as an NVMe namespace. As far as the client device (e.g., 122 in FIG. 2) is concerned, this space is allocated for use in storing and retrieving user data. As will be recognized, less than all of this space may be utilized at a given time; alternatively, the client may elect to provide storage of a large volume of data (e.g., an object, a container, etc.) as required. For ease of discussion, this client level namespace is identified in FIG. 5 as “Namespace 1 (NS-1)”.

Block 222 represents the corresponding allocations that may be made by the bridge device 200 to accommodate the client level namespace NS-1 in a first embodiment. In this example, an equal, corresponding portion 224 of the storage capacity of each of four drives (denoted as Drives A-D) is selected to provide a hidden, consolidated namespace. For example, if the NS-1 namespace covers 2 TB (10¹² bytes) of data, then each of the subblocks 224 in block 222 will be nominally 500 MB (10⁹ bytes) of storage. To the extent that the client device forwards data for storage to the namespace NS-1, the bridge device 200 will divide this so as to nominally distribute this data equally among the drives A-D. Each drive will accordingly have and process a local namespace (e.g., Drive A will have local namespace NS-A; Drive B will have a local namespace NS-B, and so on).

Adjustments may be made such that one device stores more data than another device at any given time, but overall workload will be distributed and level loaded by the bridge device 200 such that each of the drives will have nominally the same average workload.

The bridge device 200 may enact different protocols and security operations depending on the workload history of the client. Larger data transfers may be subjected to a first distribution profile, such as RAID-5 so that the input data are divided equally (along with parity) to the various drives. Smaller and/or faster turned/updated data sets may be simply stored directly to one of the devices (or a lower level of RAID processing may be supplied such as data mirroring via RAID-1, etc.). Accordingly, while the consolidated namespace 222 is shown to be nominally the same size as the allocated client-side namespace NS-1, it will be appreciated that the consolidated workspace may be some percentage larger to accommodate worst-case parity storage requirements. For example, if five (5) drives are enacted with RAID-5 capabilities, the overall allocated space may be upwards of 20% larger than the client level namespace NS-1, etc.

Block 226 shows another, alternative arrangement of a consolidated namespace that can be provisioned to accommodate the client level namespace NS-1. In block 226, each of four drives (A-D) are allocated different respective amounts of storage capacity 228 to make up the necessary storage space. This can be carried out for a number of reasons, including other workloads being managed by the bridge device 200. In this example, Drive A is provided with a first namespace NS-A that is significantly larger than a namespace NS-B in Drive B, etc. As before, the bridge device 200 operates to distribute the data from the client among these respective namespaces as appropriate.

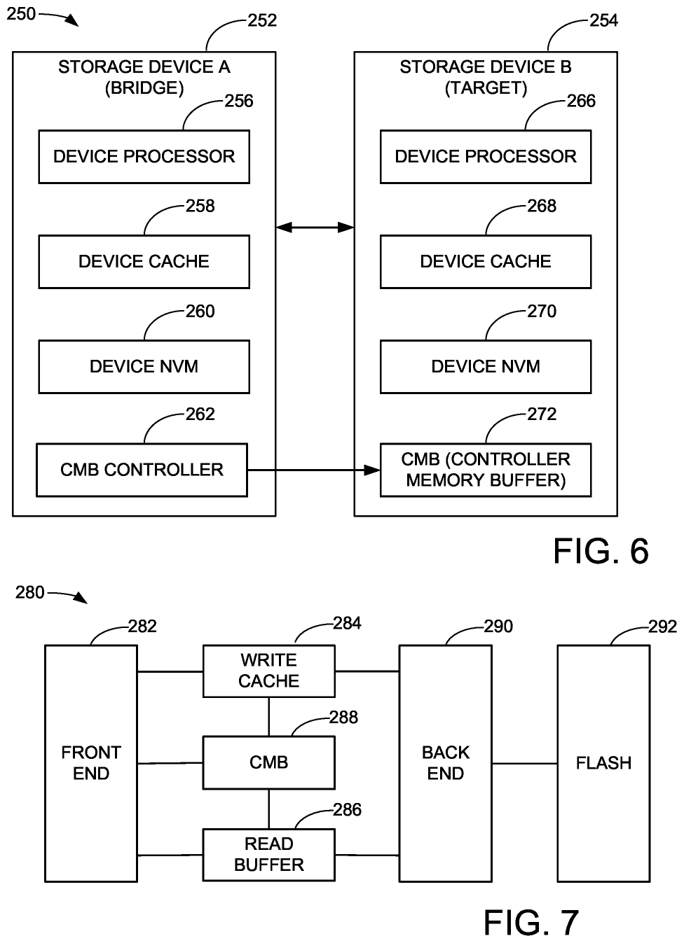

FIG. 6 shows another storage system 250 in accordance with some embodiments. A bridge device 252 is provided that corresponds to the various bridge devices discussed above, but in this case the bridge device 252 is characterized as a data storage device such as in FIG. 1. The bridge device 252 is coupled to a number of downstream data storage devices, referred to as target devices. One such target device is denoted at 254. For reference, the bridge storage device 252 is identified as Device A and the target storage device 254 is identified as Device B.

Device A 252 includes a device controller (processor) 256, a device cache 258, a device NVM (non-volatile memory) 260 and a CMB (control memory buffer) controller 262. Device B 254 similarly includes a device controller (processor) 266, cache 268, NVM 270 and CMB memory space 272. It is contemplated albeit not necessarily required that the respective devices 252, 254 are otherwise nominally identical data storage devices, such as solid-state drives (SSDs), albeit with different levels of functionality such as provisioned via different FW and command structures.

The processors 256, 266 are contemplated as programmable processors to provide various command and control functions. The caches 258, 268 provide temporary processing and storage of data during transfers. The NVMs 260, 270 are main memory storage locations, such as flash memory.

The CMB controller 262 operates in some embodiments in accordance with the CXL specification to implement direct access and control of the CMB 272. As noted above, this allows the bridge storage device 252 to access and control the CMB 272 directly, as if the CMB were a physical part of the bridge storage device. This can be particularly efficient if the CMB controller 262 consolidates a CMB as a local memory from each of the target devices to provide a larger combined CMB memory that can be directly accessed by the CMB controller and that spans each of the target devices.

To explain this operation more fully, FIG. 7 shows a functional block representation of a data storage device 280 that generally corresponds to the target storage device 254 in FIG. 6 in some embodiments. The device 280 includes a front end controller 282, a write cache 284, a read buffer 286, a CMB 288, a back end controller 290 and a main memory denoted as a flash memory 292.

The front end and back end controllers 282, 290 may include hardware and/or programmable processors, with the front end controller 282 handling commands and other communications with an upstream device (e.g., bridge device) and the back end controller 290 handling transfers to and from the flash memory 292.

The respective write cache 284. CM B 286 and read buffer 288 can be volatile or non-volatile memory including RAM, flash, FeRAM, STRAM, RRAM, phase change RAM, disc media cache, etc. An SOC (system on chip integrated circuit) approach can be used so that the respective caches are internal memory within a larger integrated circuit package that also incorporates the associated controllers. Alternatively, the caches may be separate memory devices accessible by the respective controllers.

The CMB 288 may be available memory that is specifically allocated as needed, and is otherwise used for another purpose (e.g., storage of map metadata, readback data, etc.). In one non-limiting example, the write cache 284 is non-volatile flash memory to provide non-volatile storage of pending write data, and the CMB 286 and read buffer 288 are formed from available capacity in one or more DRAM devices.

While not limiting, it is contemplated that the flash is NAND flash and stores user data from the client device in the form of pages. A total integer number N of data blocks may make up each page, with each data block storing some amount of user data (e.g., 4096 bytes, etc.) plus some number of additional bytes of error correction codes (ECC), such as LDPC (low density parity check). Additional processing supplied to the data stored to the flash may include the generation of parity sets, outer codes, run-length limited encoding, encryption, and RAID processing for data sets distributed by the bridge circuit across multiple namespaces. As such, it may be desirable in some embodiments to perform some of these functions at the bridge device level using the CMB controller 262 and CMB 272 in FIG. 6.

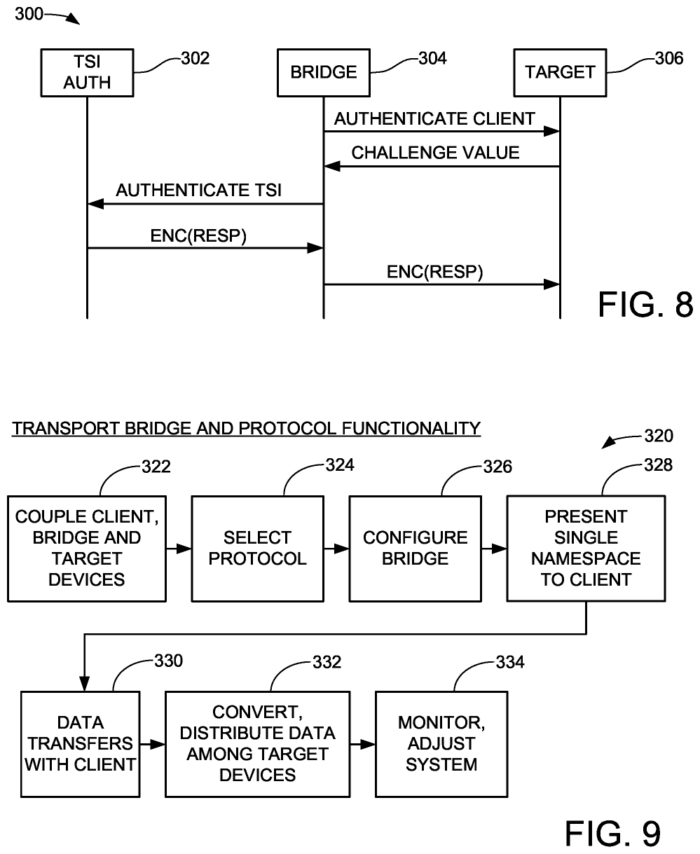

It is contemplated that the system will operate to provide secure transfer operations. As part of this, the bridge device will authenticate each of the downstream target devices to provide a trust boundary in which these devices operate. In addition, authentication steps may be carried out to authenticate each client device that establishes a namespace and accesses the bridge device. To this end, FIG. 8 shows an example authentication processing sequence 300 that can be carried out in some embodiments.

In FIG. 8, a trusted security infrastructure (TSI) 302, also sometimes referred to as the TSI authority or the TSI authority circuit, is a logical entity comprised of hardware and/or software designated to handle certain functions within the protection scheme. In some cases the TSI authority 302 may be a separate server dedicated to this purpose, or may be managed and distributed as required among various nodes by authorized system administrators (administrative users).

A bridge device 304 may initiate the authentication process such as by requesting an encrypted challenge string from a selected target device 306. This may include an initial value which is then encrypted by the drive, or some other sequence may be employed. The challenge value may be forwarded to the TSI 302, which processes the challenge value in some way to provide an encrypted response, which may be processed by the bridge and the target. In this way, the bridge and the target are authenticated to each other as well as to the TSI authority (thereby establishing a trust boundary as in FIG. 2).

Similar steps can be carried out for each of the other target devices in the array, as well as each client that is granted access to the system. It will be noted that other authentication schemes can be carried out, including schemes that rely on local information among the bridge and targets to provide local authentication.

FIG. 9 provides a sequence diagram 320 for a transport bridge and protocol functionality operation in accordance with various embodiments. The flow of FIG. 9 sets forth general steps that may be sequentially carried out to process data using the various systems described herein. It will be appreciated that the flow can be modified, appended, performed in different orders and so on depending on the requirements of a given application.

Block 322 shows an initial processing operation in which various elements of the system are coupled and authenticated. As described above this can include physical and electrical interconnection of various devices, either locally or over a network. The bridge and target devices may be separately authenticated as a unit, followed by an authentication of a client device to interface and perform data transfers with the unit.

Block 324 shows the selection of a suitable protocol for the operation of the system. In some embodiments, this can include designation of the NVMe specification or some other suitable protocol. Block 326 shows a resulting configuration of the bridge device and block 328 represents the formulation and presentation of a single namespace to the client. It will be appreciated that the respective steps 324 may be initiated by a request from the client for a selected capacity of memory, which in turn is configured by the bridge device through the allocation of associated memory in the applicable target devices. Some measure of parameters and data exchanges may take place at this point. It will be noted that, in at least some embodiments, from the client device perspective the processing is normal so as to be indistinguishable from a conventional allocation of a namespace to carry out desired processing. Similarly, at the target device level, similar processing may take place to select and configure individual namespaces based on inputs supplied by the bridge device. However, at the bridge device level, consolidation and emulation of the requested memory and performance requirements from the client are translated and configured so as to break the emulated namespace into individual namespaces that are consolidated into the overall space.

As a result, the bridge device can make intelligent decisions to select the number of devices, the amount of space to be allocated from each device, additional layers of processing (including RAID techniques, encryption, etc.) to be applied, and so on. The operation of the bridge device is thus hidden and not apparent to either the client or target devices (e.g., the client is unaware the namespace is emulated, and the target devices are unaware the individual namespaces being generated and managed at the device level form part of a larger consolidated namespace). In some cases, multiple namespaces that make up the consolidated namespace may be partially or fully on the same target device.

Continuing with FIG. 9, data transfers are thereafter carried out between the client device and the operational unit formed by the bridge and target devices, block 330. In an NVMe environment, such operations will appear to be carried out at the client level in a manner similar to that described above in FIG. 2. However, processing and lower levels of namespace processing are carried out at block 332 to manage the data transfers as described above. Block 334 shows that during operation, the system performance will be monitored at the bridge device level, and adaptive adjustments to the system are carried out as required.

For example, the bridge device may allocate additional devices/memory space for specific operations to maintain a selected level of performance/service. By atomizing the namespaces at the individual target device level, the bridge device can seamlessly make adjustments including releasing some namespaces and substituting others while presenting the same namespace to the client device. Other operational advantages will readily occur to the skilled artisan in view of the present disclosure.

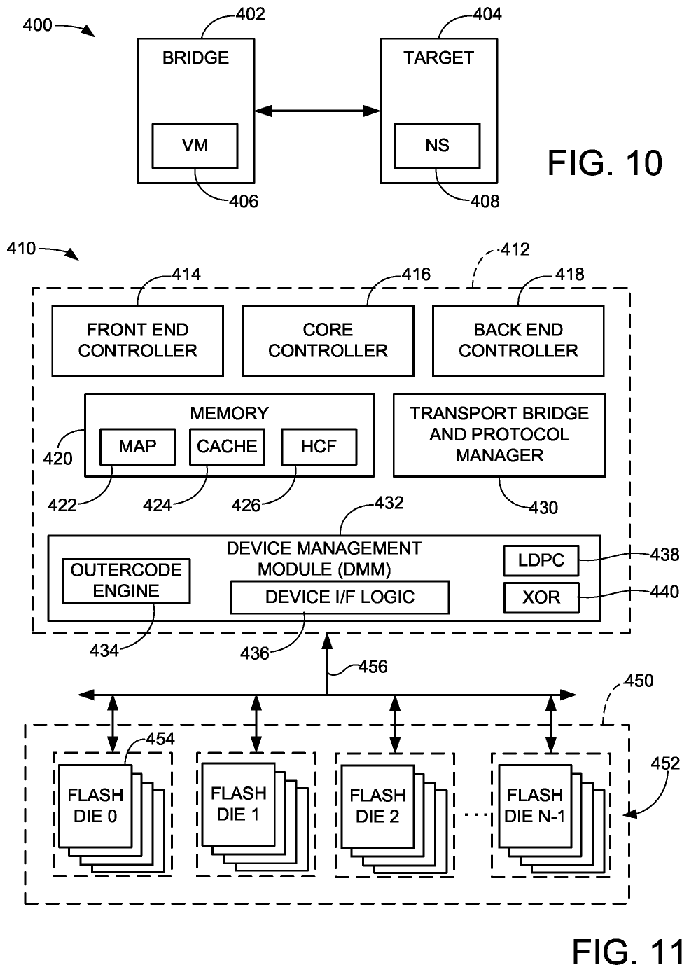

FIG. 10 shows another system 400 constructed and operated in accordance with various embodiments. The system 400 includes a bridge 402 and a target device 404 which generally operate as described above. In this case, further enhancements include the operation of a virtual machine (VM) 406 as a layer of the processing operations at the bridge level to manage the respective namespaces (NS) 408 at each target device.

The foregoing description of various embodiments can be carried out using any number of different types of processing device and storage device configurations. The bridge devices can take any number of suitable forms, including servers, control boards, storage devices, etc. In some embodiments, data storage devices configured as solid-state drives (SSDs) are particularly suited to carry out the functionality described herein at the respective target and/or bridge levels. To this end, FIG. 11 is a functional block representation of an SSD 410 constructed and operated to be incorporated in any of the foregoing example embodiments as desired.

The SSD 410 includes a controller circuit 412 that generally corresponds to the controller 104 of FIG. 1. The controller circuit 412 includes a front end controller 414, a core controller 416 and a back end controller 418. The front end controller 416 performs client (host) I/F functions, the hack end controller 420 directs data transfers with the NVM (flash memory 450) and the core controller 416 provides top level control for the device 410.

Each controller 414, 416, 418 includes a separate programmable processor with associated programming (e.g., firmware, FW) in a suitable memory location, as well as various hardware elements to execute data management and transfer functions. This is merely illustrative of one embodiment; in other embodiments, a single programmable processor (or less/more than three programmable processors) can be configured to carry out each of the front end, core and back end processes using associated FW in a suitable memory location. Multiple programmable processors can be used in each of these operative units. A pure hardware based controller configuration, or a hybrid hardware/programmable processor arrangement can alternatively be used. The various controllers may be integrated into a single system on chip (SOC) integrated circuit device, or may be distributed among various discrete devices as required.

A controller memory 420 represents various forms of volatile and/or non-volatile memory (e.g., SRAM, DDR DRAM, flash, etc.) utilized as local memory by the controller 412. Various data structures and data sets may be stored by the memory including one or more metadata map structures 422, one or more sets of cached data 424, and one or more CMBs 426. Other types of data sets can be stored in the memory 420 as well.

A transport bridge and protocol manager circuit 430 can be provided in some embodiments, particularly for cases where the SSD 410 is configured as a bridge and protocol transport. The circuit 430 can be a standalone circuit or can be incorporated into one or more of the programmable processors of the various controllers 414, 416, 418.

A device management module (DMM) 432 supports back end processing operations. The DMM 432 includes an outer code engine circuit 434 to generate outer code, a device OF logic circuit 436 to provide data communications, and a low density parity check (LDPC) circuit 438 configured to generate LDPC codes as part of an error detection and correction strategy used to protect the data stored by the by SSD 410. One or more XOR buffers 440 are additionally incorporated to temporarily store and accumulate parity data during data transfer operations.

The memory module 114 of FIG. 1 is realized as the aforementioned flash memory 450 which includes an NVM in the form of a flash memory 442 distributed across a plural number N of flash memory dies 444. Rudimentary flash memory control electronics may be provisioned on each die 444 or for groups of dies to facilitate parallel data transfer operations via a number of channels (lanes) 446.

It can be seen that the functionality described herein is particularly suitable for SSDs in an NVMe and/or CXL environment, although other operational applications can be used. In some cases, the diagram of FIG. 2 (e.g., NVMe controller and namespace) can be understood as being implemented at different levels and layers in the system; to the external client, the bridge device appears as the NVMe controller for the unitary namespace. To the individual target devices, the bridge device appears as the client.

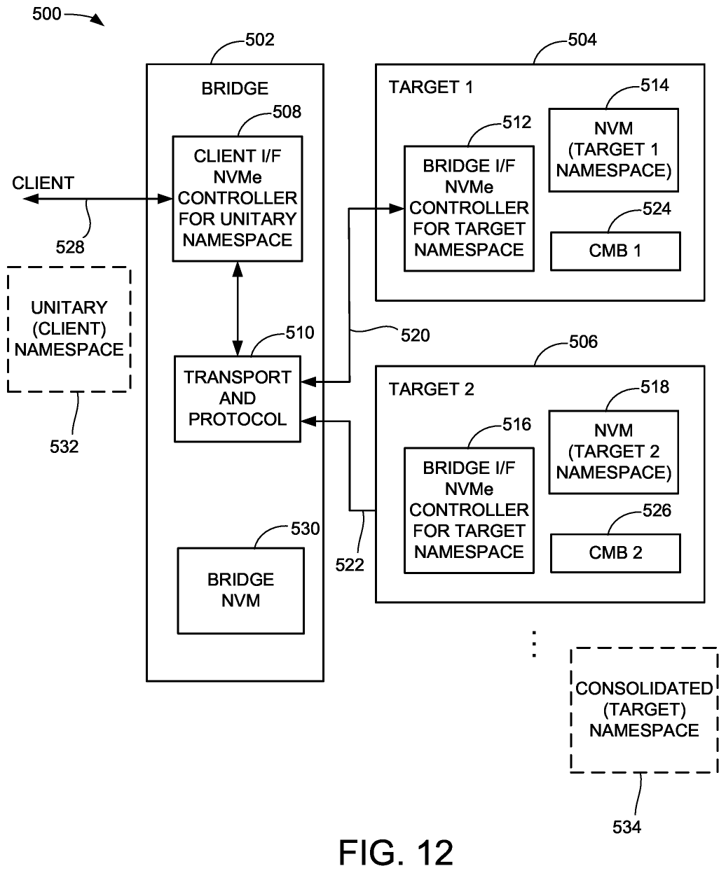

This arrangement can be understood with a review of FIG. 12, which provides yet another system 500 constructed and operated in accordance with various embodiments. While not limiting, it is contemplated that a bridge device 502 and respective target devices 504, 506 are all data storage devices, such as the SSD 410 in FIG. 11. While only two target devices are shown, any number can be used or added as needed. Moreover, it is contemplated that the system 500 operates in accordance with both the NVMe and CXL specifications.

The bridge device 502 includes a controller 508 that operates as described above as a client OF NVMe Controller for a Unitary Namespace, namely, the namespace presented to the client device as illustrated including in FIGS. 2 and 5. The bridge device further incorporates a transport and protocol module 510 which performs the bridging and protocol conversions and control to communicate with each of the respective target devices 504, 506.

The first target device 504 (“Target 1”) has a controller 512 as described above that also operates as a Bridge OF NVMe Controller for a Target Namespace at the device level. The namespace incorporates some or all of the associated NVM 514. In this way, the bridge device 502 operates, as far as the target device 504 is concerned, as the client. Similar, independent operation is carried out for the second target device 506 (“Target 2”), which has respective controller 516 (operative as a Bridge OF NVMe Controller for a Target Namespace) for the associated namespace formed from some or all of the capacity of NVM 518. Hence, the bridge device 502 operates, at least as far as the second target device 506 is concerned, as the client device. Separate communication pathways 520, 522 are supplied to enable parallel operation and data transfers.

Each of the target devices 504, 506 further have an optional CMB 524, 526 as local memory that can be allocated and controlled by the bridge device 502. These respective CMBs form a larger, consolidated memory that spans the various target devices, further enabling data transfers to take place between the bridge device and the target devices.

Finally, FIG. 12 shows a separate interface as a network connection (e.g., PCIe, etc.) for the external client to communicate with the bridge device 502 to access the unitary (client) namespace (broken line box 532). In some cases, the bridge device 502 can also include an NVM 530 that, as desired, can be incorporated into the consolidated (target) namespace (broken line box 534) formed from the individual namespaces at the target (device) level.

It is contemplated that the unitary namespace 532 will have a first selected capacity, and the consolidated namespace 534 will have a second, larger capacity. The additional capacity enhances processing and transfer efficiencies and allows the bridge device 502 to flexibility to store and distribute the data as required (e.g., RAID-5 with parity, RAID-1 with mirroring, etc.). The bridge device 502 can further make adjustments on-the-fly to the consolidated namespace by adding or dropping individual namespaces to meet ongoing needs of the system in a manner that is wholly transparent to the client.

In this way, the bridge device can operate as an NVMe controller with respect to the client device for the unitary namespace, and as a virtual client device to each of the target devices which operate as embedded NVMe controllers for the individual namespaces.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method comprising:
establishing a secure connection between a client device and a bridge device across an interface;
using a controller of the bridge device to present a unitary namespace as an available memory space to the client device using a selected protocol; and
communicating, via the controller of the bridge device, with a plurality of downstream target devices each characterized as a storage device having a main memory store, the controller allocating individual namespaces within the main memory stores of each of the target devices to form a consolidated namespace to support the unitary namespace presented to the controller, and servicing data transfer commands to transfer data between the client device and the individual namespaces of the target devices.

2. The method of claim 1, wherein the unitary namespace and the individual namespaces are each characterized as NVMe (Non-Volatile Memory Express) namespaces, wherein the bridge device operates as an NVMe controller that interfaces with the client to support the unitary namespace, and wherein a target controller of each of the target devices operates as an NVMe controller for the associated individual namespace to interface with the bridge device.

3. The method of claim 1, wherein the unitary namespace presented to the client device comprises a single namespace having a first capacity, wherein the individual namespaces of the target devices forms an overall consolidated namespace with a second, larger capacity, and wherein the controller of the bridge device distributes data received from the client device across the individual target devices using at least one RAID-level type of processing.

4. The method of claim 1, wherein the bridge device is coupled to the client via a first interface path and coupled to each of the target devices via a second interface path, the second interface path configured to facilitate concurrent, parallel data transfers between the respective bridge device and target devices.

5. The method of claim 1, wherein the bridge device is a storage device nominally identical to each of the target devices.

6. The method of claim 1, wherein the bridge device and target devices are each characterized as a solid-state drive (SSD).

7. The method of claim 1, wherein the controller of the bridge device comprises an ARM processor with associated programming in a local memory.

8. The method of claim 1, wherein the main memory store of each of the target devices comprises flash memory.

9. The method of claim 1, wherein the controller of the bridge device uses a command memory buffer (CMB) protocol in accordance with a CXL specification to access a corresponding local memory in each of the target devices as a CMB.

10. The method of claim 1, further comprising performing a prior step of establishing a trust boundary via an authentication operation that includes the client device, the bridge device and the target devices.

11. An apparatus comprising:
a plurality of data storage devices each having a storage device controller and a non-volatile memory (NVM); and
a bridge device coupled to each of the plurality of data storage devices and having a bridge device controller configured to interface with each of the storage device controllers and an external client device, the bridge device controller configured to present a unitary namespace as an available memory store to the client and to allocate individual namespaces from the NVMs of the data storage devices to form a consolidated namespace to support data transfer operations from the client device.

12. The apparatus of claim 11, wherein the unitary namespace and the individual namespaces are each characterized as NVMe (Non-Volatile Memory Express) namespaces, wherein the bridge device operates as an NVMe controller that interfaces with the client to support the unitary namespace, and wherein the data storage device controller of each of the target devices operates as an NVMe controller for the associated individual namespace to interface with the bridge device which issues NVMe commands to the storage device controllers responsive to NVMe commands from the client device.

13. The apparatus of claim 11, wherein at least one of the individual namespaces of the data storage devices is used to store parity data in accordance with a selected RAID level and at least some of the remaining individual namespaces of the data storage devices store stripes of user data protected by the parity data.

14. The apparatus of claim 11, wherein the bridge device is coupled to the client via a first interface path and coupled to each of the data storage devices via a second interface path, the second interface path configured to facilitate concurrent, parallel data transfers between the respective bridge device and data storage devices.

15. The apparatus of claim 11, wherein the bridge device is a storage device nominally identical to each of the plurality of data storage devices.

16. The apparatus of claim 15, wherein the bridge device and plurality of data storage devices are each characterized as a solid-state drive (SSD), wherein the bridge device includes an NVM, and wherein the NVM of the bridge device is configured as an individual namespace that makes up the consolidated namespace.

17. The apparatus of claim 11, wherein the controller of the bridge device comprises an ARM processor with associated programming in a local memory to both operate as an NVMe controller for the client device and as a virtual client device for each of the storage device controllers which in turn are configured to operate as NVMe controllers.

18. The apparatus of claim 11, wherein the NVM of each of the target devices comprises flash memory.

19. The apparatus of claim 11, wherein the controller of the bridge device uses a command memory buffer (CMB) protocol in accordance with a CXL specification to access a corresponding local memory in each of the target devices as a CMB.

20. A solid-state drive (SSD), comprising:
a non-volatile memory (NVM) comprising NAND flash memory; and
a controller configured to operate as an NVMe controller via an interface for an external client device to present a unitary namespace in accordance with an NVMe specification, the controller further configured to operate as a virtual client device for a plurality of additional SSDs coupled to the SSD via a second interface.
